(19) United States
(12) Patent Application Publication
(10) Pub. No.: US 2005/0235570 A1
(43) Pub. Date: Oct. 27, 2005

(54) Automatic sliding door

(76) Inventor: Lothar Ginzel, Schwerte (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/517,856

(22) PCT Filed: Apr. 16, 2004
(86) PCT No.: PCT/EP04/04106

§ 371 Date: Dec. 14, 2004

(30) Foreign Application Priority Data
Apr. 17, 2003 (DE) 103 18 160.1

(51) Int. Cl. E05D 13/00

(52) U.S. Cl. 49/409

(57) ABSTRACT

Automatic sliding door with at least one displaceable leaf which is operatively coupled to a driving motor so that the door leaf/leaves can be opened and closed. Each leaf has a frame comprising profiles in which a pane of glass is held, and a light source provided in at least one of the profiles, the light source being supplied with electrical energy by a power supply.

The invention is directed to an automatic sliding door according to the characterizing features of patent claim 1.

DE 40 14 727 A1 shows an automatic sliding door in which at least one leaf is displaceable. Depending upon application, stationary side parts or swivelable side parts combined with the displaceable leaves are also provided in addition to the displaceable leaves. The displaceable leaf and the stationary leaf are joined by a crossbar located above the door.

It is the object of the present invention to provide an automatic sliding door which is improved with respect to its visual effect and which further offers a greater degree of safety, particularly for older persons.

This object is met by the features indicated in patent claim 1. Advantageous embodiments of the subject matter of patent claim 1 are indicated in the subclaims.

Apart from the improved visual effect, the safety potential is increased enormously at the same time by the illumination of the individual panes of glass which comprises the side parts as well as the sliding leaves. The individual panes of glass can be lit with many different colors. Further, it is also possible that the panes of glass can change colors depending upon the direction in which the person enters.

The lighting means are provided inside the profiles enclosing the glass panes or in the seals that can be located at the profiles. This enlivens the large-area elements of the glass panes and makes it possible to adapt better to different room situations.

According to an advantageous further development, the light enters via the edges of the glass panes. This not only produces an imaginative effect that can be further enhanced by providing the elements with patterns such as stripes, bubbles or the like, but also enhances the visual effect when the light can be controlled in intensity. Through the use of correspondingly designed panes in which the light is refracted or by means of a corresponding etching of the surface or printing of the surface, a uniform light distribution can accordingly be achieved over the entire pane of glass.

The light can be introduced into the glass panes in a particularly simple manner when the lighting means are arranged in front of the glass edges of the individual glass panes. In this way, the light can be introduced directly in the plane of the pane of glass.

In order to protect the lighting means from harmful external influences such as water, moisture, etc., the profile and/or the seal in an advantageous further development have/has a cavity in which the lighting means, preferably an LED, is arranged. Instead of LEDs, other lighting means, preferably having a low energy consumption, can also be used.

Protection of the individual lighting means from external influences can be further improved in an advantageous further development when the cavity is filled with a sealing compound. This safely and reliably prevents the penetration of moisture and therefore prevents damage to the lighting means or even endangerment of the person using a sliding door.

According to a preferred embodiment form, the lighting means extend at least along part of the length of the glass panes, but preferably over the entire vertical length. Therefore, the lighting means are preferably provided only at the vertical or horizontal edges of the glass.

When the stationary part is formed by a guide rail and the movable part is supported at this guide rail so as to be displaceable in longitudinal direction of the guide rail, it is advantageous when a stationary current rail is provided at the guide rail and a current collector which moves along with the displaceable leaf is provided at the displaceable leaf in a further development according to the invention. This constructional variant enables a reliable and safe transfer of current particularly in sliding doors.

According to an advantageous further development, the current rail extends in longitudinal direction of the guide rail. A construction of this kind ensures that the current rail can be accommodated in the guide rail so as to be substantially protected against water so that the current rail cannot constitute a danger.

The current rail is preferably connected to the guide rail by insulation.

According to an advantageous further development, two current rails extending parallel to one another are supported at the guide rail and two current collectors which are preferably curved in a hook-like manner are guided in a sliding manner at the current rails. It is ensured in this way that the current is supplied to the electrical consumers in a reliably functioning manner.

Instead of the current conductors which can also be arranged freely in the crossbar, i.e., without a guide rail, trailing cables can be guided to the displaceable leaves. This construction ensures that power can be supplied to a moving leaf in an inexpensive and reliable manner.

Further details, features and advantages of the invention are indicated in the following description of a preferred embodiment example with reference to the drawings.

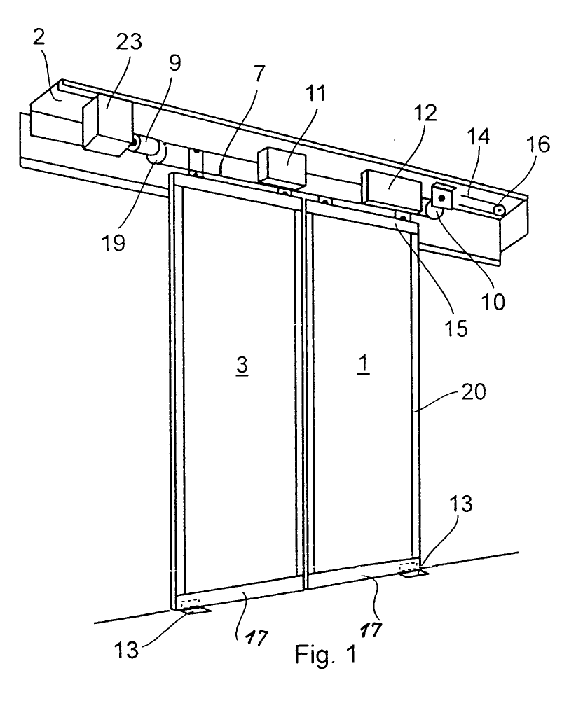

FIG. 1 shows a perspective view of an automatic sliding door;

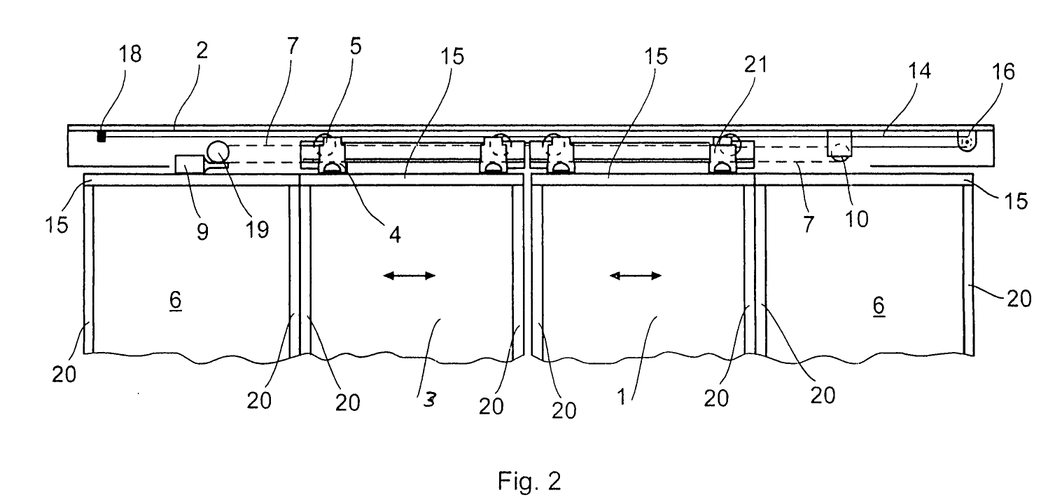

FIG. 2 shows a top view of an automatic sliding door with side parts;

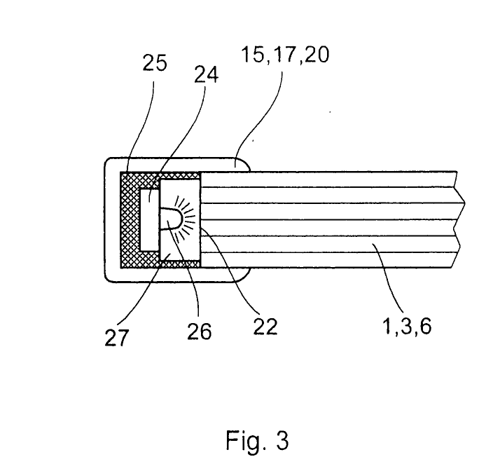

FIG. 3 shows a section from a glass edge of a side part or a leaf.

The embodiment example of a sliding door shown in FIG. 1 shows a door leaf 1 and 3. The door leaves 1 and 3 are framed by corresponding profiles 15, 17, 20. The door leaves 1 and 3 are guided in the floor area by means of floor sliders 13. A crossbar 2 in which the driving means are substantially accommodated is located above the leaves 1 and 3. These driving means comprise a power supply 23, a driving motor 9 with a toothed disk drive 19 and driving means 7 which are in an operative connection with the latter and which are guided over a deflecting roller 10. Further, a regulating device 11 and a monitoring device 12 are provided in order to ensure proper operation of an automatic sliding door of this kind. The leaves 1, 3 are displaceable by means of a suspension device 4 in combination with running rollers 5.

Further, an auxiliary drive is provided inside the crossbar 2 and substantially comprises an elastic element 14 which is guided over a deflecting roller 16 and which is in a working connection with the door leaves 1 and 3. During the normal closing of the door leaves 1 and 3, the supplied energy is stored inside the auxiliary drive. During a power outage and therefore with simultaneous decoupling of the normal drive, this energy takes effect in such a way that the door leaves 1 and 3 automatically open. FIG. 2 shows the cooperation of the auxiliary drive and the normal drive. It can also be seen that there are stationary side parts 6 in addition to the displaceable leaves 1 and 3.

FIG. 3 shows lighting means arranged in the profiles 15, 17, 20 or in seals, not shown, which are arranged at the latter. Lighting means are placed in front of the front edge 22 of the glass panes 1, 3, 6 in such a way that the irradiated light, e.g., from an LED 26, is directed to the front edge 22. A light distribution that is as uniform as possible is achieved by means of a cavity around the lighting means. Other lighting means having low energy consumption can be used instead of an LED. A circuit board 24 to which the LEDs 26 are electrically connected and on which they are also held mechanically is arranged on the side of the cavity 27 remote of the front edge 22. The LEDs 26 can be provided on at least one of the front edges 22 of at least one glass pane 1, 3, 6 and extend along at least a portion of the length of the front edges. However, the arrangement of the LEDs 26 is particularly effective when they are arranged over the entire vertical and/or horizontal extension of the panes of glass. The cavity inside the profiles 15, 17, 20 in which the LEDs 26 are located is completely or partly filled with a sealing compound 25 to protect against the penetration of moisture and to prevent damage.

The LEDs 26 can be provided with an additional circuit which makes it possible to vary the light radiated by the LEDs 26 with respect to the time during which they are turned on and with respect to its brightness and/or color mixture. Further, the LEDs 26 can be controlled depending on the incident daylight, depending on a person or according to any other program. In order to provide the electrical consumers, in this case the lighting means, with electrical energy, two current rails extending parallel to one another in the longitudinal direction of the leaves 1, 3 and 6 can be arranged in the guide rails, not shown. The current rails are arranged in the crossbar 2 by means of corresponding insulation.

In order to transfer the energy from the current rails to the moving leaves, the latter can be realized by means of corresponding current collectors.

It is also conceivable to supply the electric energy to the consumers (LEDs 26) by means of trailing cables which are located inside the crossbar 2.

### REFERENCE NUMBERS

1 door leaf
2 crossbar
3 door leaf
4 suspension device
5 running rollers
6 side parts
7 driving means
9 driving motor
10 deflecting roller
11 regulating device
12 monitoring device
13 floor slider
14 rubber element
15 upper transverse profile
16 deflecting roller
17 lower transverse profile
18 point of attachment to the crossbar
19 toothed disk drive
20 profile
21 running carriage
22 front edge
23 power supply
24 circuit board
25 sealing compound
26 LED
27 free space

1-10. (canceled)

11. An automatic sliding door comprising:
at least one displaceable leaf comprising a pane of glass having horizontal and vertical edges framed by an upper profile, a lower profile, and a pair of vertical profiles;
a drive motor coupled to said at least one leaf for displacing said at least one leaf to open and close the door; and
a light source provided in at least one of said profiles.

12. An automatic sliding door as in claim 11 further comprising:
at least one stationary side part comprising a pane of glass having horizontal and vertical edges framed by an upper profile, a lower profile, and a pair of vertical profiles; and
a light source provided in at least one of said profiles of said at least one stationary side part.

13. The automatic sliding door of claim 11 wherein each said light source emits light into a respective edge of a pane of glass.

14. The automatic sliding door of claim 13 wherein each said light source faces a respective edge of the pane of glass.

15. The automatic sliding door of claim 11 wherein at least one of said profiles comprises a cavity in which said light source is located, said light source comprising a plurality of LEDs.

16. The automatic sliding door of claim 15 wherein each said cavity is at least partially filled with a sealing compound.

17. The automatic sliding door of claim 11 wherein said light source is provided in each of said profiles and extends the length of each said edge.

18. The automatic sliding door of claim 11 further comprising a current feed in the upper profile of each said displaceable leaf.

19. The automatic sliding door of claim 18 further comprising a stationary crossbar from which the at least one displaceable leaf is suspended, said current feed comprising a trailing cable from the crossbar to each said displaceable leaf.

20. The automatic sliding door of claim 18 further comprising a stationary crossbar from which the at least one displaceable leaf is suspended, said current feed comprising current rails mounted on the crossbar and a current collector mounted on each said displaceable leaf, said collector being in electrical contact with said rails.
